(19) United States
(12) Patent Application Publication
(10) Pub. No.: US 2005/0256689 A1
(43) Pub. Date: Nov. 17, 2005

(54) Method and system for measuring attributes on a three-dimenslonal object

(75) Inventor: Waldean Schulz, Boulder, CO (US)

Correspondence Address: WALDEAN A. SCHULZ, 1919 FOURTEENTH STREET, SUITE 500, BOULDER, CO, 80302, US

(73) Assignee: Conceptual Assets, Inc., Boulder, CO (US)

(21) Appl. No.: 10/844,829

(22) Filed: May 13, 2004

(51) Int. Cl. G01B 17/00

(52) U.S. Cl. 703/11; 702/155; 702/189; 73/597; 73/602

(57) ABSTRACT

The method of this invention, and the apparatus which implements it, provides a way of sampling points on the surface of a portion of a rigid or semi-rigid object, which might be an anatomical body. Points are sampled by a moveable contact probe which emits a sonic waveform under the direction of a control unit. Multiple fixed sonic transducers in contact with the object at diverse locations detect the waveform, the arrival of which is timed for each transducer by the control unit. Given the speed of sound in the object and the coordinates of the transducers, a digital computer can compute the location of the probe. Two ways are presented to calibrate the locations of the transducers. Provision is made for mitigating possible distortion of soft object surfaces due to the contact force of the probe. During the sampling of probe contact locations, at least one physical or physiological attribute is also acquired. Sampling sufficient points allows 3-d geometric construction of a model of the portion, which includes both the surface shape geometry and the distribution of the values of the attribute thereon. Finally a view of the model may be rendered on a graphical display medium.

### CROSS-REFERENCE TO RELATED APPLICATIONS

not applicable

### FIELD OF INVENTION

This invention relates to an improvement for acquiring 3-dimensional geometrical and localized physical measurements from portions of a solid, rigid or semi-rigid object and for relating each physical datum to the geometrical location at which it was acquired. In particular, the solid object could be a portion of an anatomical body, such as a human limb for example.

### BACKGROUND

Various systems, using various technologies, have been documented, developed, and patented for measuring the surface geometry of and spatial locations on physical objects, where the objects may be portions of animal or human anatomy. Such measurement systems also include those which yield full, 3-dimensional internal cross-sectional images, from which the surface shape information may be derived.

Examples of the latter systems are CT (computed tomography imaging), MRI (magnetic resonance imaging), and diagnostic ultrasound scanners. Examples of more limited systems, which determine only the surface shape, include laser scanners, moiré pattern cameras, stereometric cameras, and similar optical metrology equipment—all of which avoid mechanical contact with the object. Besides those are contact-based, mechanical systems like CMMs (coordinate measuring machines) with touch-sensitive probes, which can be automated to sample many points on the surface of an object. All the above are commercially available, are well known, are common in both medical and industrial markets, and are represented by numerous products from many manufacturers.

Besides the above, there are systems which track the 3-dimenstional location of the tip of a manually moved probe. Some systems mechanically track the probe tip using articulated arms with accurate, electronic joint rotation sensors. Other systems track the location of the probe electro-optically. Still others track the probe electro-magnetically. Like the aforementioned systems, each of these is commercially available from more than one manufacturer. All of these have been employed in both industrial and medical applications to measure the XYZ coordinates of individual points on the object of interest. If sufficient points are measured densely enough, a useful surface model of the object can be generated and graphically displayed by an associated electronic computer. Preferably the object of interest is rigid, but, if only semi-rigid (such as an anatomical body), then at least it can be kept essentially fixed in shape while the measurements are taken.

The system and technology most relevant to the present invention is the sonic-based Freepoint 3D™ Sonic Digitizer by GTCO Calcomp (Columbia, Md.). See also U.S. Pat. Nos. 4,956,824 and 5,379,269 by Sindeband, et al. This device tracks the location of a hand-held probe outfitted with two or more sonic impulse emitters. Electronic timing circuits then measure the distance between each emitter and each of at least three microphones (arranged in a triangular array) by measuring the transit time of the sound pulse through air from each emitter to each microphone (which are at known locations in a 3-d coordinate system). From those distances the XYZ coordinates of the probe tip can be computed by finding the intersection of three spheres centered respectively at the microphones and having radii equal to the three respective distances. (Two such points actually exist, but usually only one is the obvious solution. This ambiguity can be eliminated if more than three microphones are used and are not all in the same plane.)

One limitation of the above system in measuring many points on an object is that the object must remain in a fixed location and orientation during the measurement session. If not, the location and orientation of the object itself must also be explicitly tracked in addition to the position of the probe. In this latter case, the probe tip location can be computed as coordinates within a local coordinate system which moves fixedly with the object. That is, the object itself, in addition to the probe, has sonic impulse emitters attached to it—three or more. Both the probe and the object are then tracked relative to a global coordinate system relative to the microphone array. Then by using well know methods of matrix algebra (inverse transformations and composite transformations), a local coordinate reference system is defined in a fixed relationship to the tracked object, and the probe coordinates can be computed relative to it. (See U.S. Pat. No. 5,920,395.) This is required because the microphone frame is not usually fixedly attached to the object of interest, and the microphone array provides a coordinate system for the tracking device to which both the object and the probe are referenced. It would be beneficial to avoid this added complexity (and source of further inaccuracy) by attaching the microphones directly to the object of interest.

Another limitation of a sonic system is that temperature variations (and to a lesser extent humidity and pressure) greatly influence the accuracy of the system. Therefore, sonic systems typically have some provision to compensate for temperature or to measure the speed of sound between a sonic impulse emitter and a microphone separated by a known distance.

A further limitation of the optical systems is that maintaining “line-of-sight” through the air is generally problematic. This may restrict measurement of all sides of the object of interest, including its “far side” and “the bottom”). Mechanical arms and CMMs have a similar problem freely accessing all sides of an object. Magnetic systems overcome the line-of-sight limitation, but only if the object is non-metallic and there are no ferromagnetic objects nearby to distort the measurements.

For some applications, including some medical applications, the non-contact (optical) systems described above are not appropriate, because in addition to the spatial location data other physical measurements are being acquired, which require contact with the object of interest. For example, color or even temperature could be acquired without contact by a probe, but surface elasticity or electrical conductivity could not.

Therefore, in light of the foregoing limitations of existing approaches, the first objective of this invention is to provide a system which can acquire the surface shape of a rigid object or of a semi-rigid object which is temporarily maintained at a nearly fixed shape. A second objective is to acquire the values of at least one physical or physiological attribute at they relate to locations on the surface of the object. A third objective is to compensate for any local distortion (if any) caused by the force of contact of a probe with a soft surface. A fourth objective is to do so without the usual line-of-sight and environmental limitations of conventional 3-d surface point measuring systems (such as temperature, lighting, or magnetic distortion). A fifth objective is to do all this relatively inexpensively.

The principal advantage of a system satisfying these objectives is that it could be usefully applied to medical applications involving portions of anatomy such as arms or legs.

### SUMMARY OF THE INVENTION

To accomplish the stated objectives, the present invention comprises a geometrical 3-dimensional coordinate system, a moveable contact probe, a plurality of sonic receivers, a timing and control unit, a digital computer comprising appropriate computation hardware and software, and a graphical display. In one enhanced embodiment, the sonic receivers could also transmit sound, so hereafter they will be referred to as sonic transducers. The probe itself comprises a sonic waveform transmitter for localization purposes. It further comprises a collocated sensor for measuring the local value of at least one local physical or physiological attribute of the portion of the object or anatomy of interest. The attribute, for example, might be the surface normal direction, the surface temperature, or the softness of the surface of the object at the point of contact. The probe is intended to be moved manually but could be moved robotically. Consideration is given to correcting the local distortion of soft surfaces due to the force of contact of the probe.

The method of operation of the invention comprises steps of
affixing the transducers on the object,
establishing a 3-dimensional coordinate system (3-d reference frame),
calibrating the locations of the transducers within the 3-d coordinate system,
repeatedly generating a sound waveform from a moveable probe and injecting it into the object,
moving and contacting the probe with sufficiently many points on the surface,
acquiring the transit time of the sound waveform from the probe contact point to each transducer,
measuring at least one particular physical attribute at each contact point,
maintaining a constant overall shape of the object during the preceding steps,
computing distances from the transit times and the speed of sound in the object's material,
computing the location of each contact point using those distance and the transducer locations,
mitigating any local surface distortion from the probe's contact force on soft material,
recording the 3-d location of each contact point and the associated physical measurement,
constructing a geometrical and physical model from the recorded data, and
displaying a graphical rendering of the constructed model.

While one important application of this invention is for use with animal or human anatomy, it may equally well be applied to inanimate objects—especially solid bodies comprised of homogenous material.

### DESCRIPTION OF THE DRAWINGS

The accompanying drawings, which are incorporated herein and form a part of the specification, illustrate a preferred embodiment of the present invention and, together with the description, serve to explain the principle of the invention.

FIG. 1 is a simplified perspective view of the major components of the whole invention

FIG. 2 is a more detailed view of the contact probe.

FIG. 3 is a geometry diagram illustrating the computation of the coordinates of the point of contact of the probe.

FIG. 4 shows specifically one enhancement which measures surface tissue firmness.

The numeric identifiers in the figures correspond to the elements as follows:
1 the whole system of the invention
10 the timing and control unit
12 the moveable contact probe
14 each of a plurality of sound transducers contacting anatomy 99
16 the computational unit, represented by part of a laptop personal computer
18 the graphical display, represented by part of a laptop personal computer
20 the data path between each transducer 14 and the timing/control unit 10
22 the data path between the timing/control unit 10 and the probe 12
24 the data path between the timing/control unit 10 and the computational unit 16 and display 18
26 the 3-dimensional coordinate system fixed with respect to the anatomy 99
28 the direct path of a sound waveform from the probe 12 to one transducer 14
29 an indirect path of a sound waveform from the probe 12 to a transducer 14
30 the sonic waveform transmitter housed within the probe
32 a sensor for measuring some physical attribute, such as temperature
34 an optional spring-loaded plunger to measure surface elasticity
36 the displacement sensor for plunger 34
38 the spring (with known force/displacement constant) for plunger 34
99 the object or anatomical portion being analyzed (not part of the invention)

### DESCRIPTION OF A PREFERRED EMBODIMENT

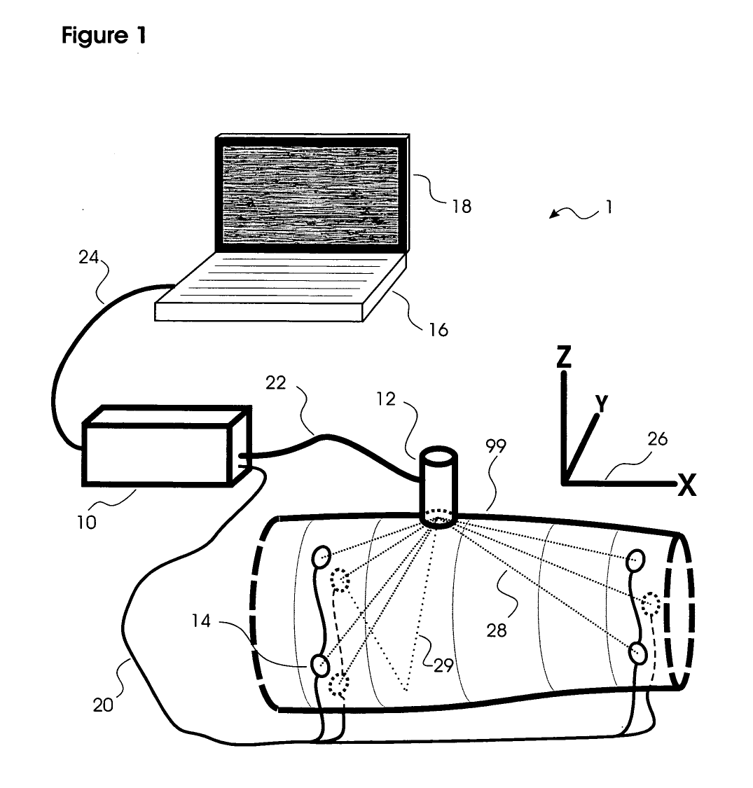

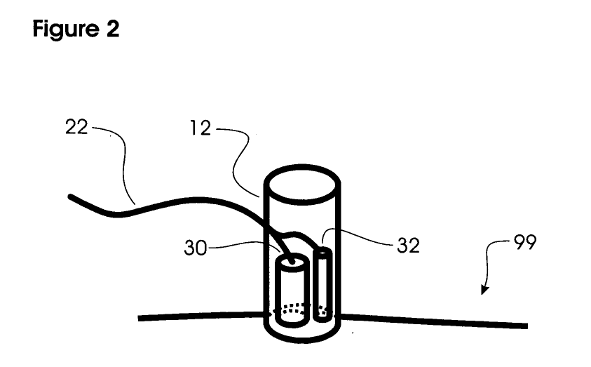

Preferred embodiment of this invention as an apparatus, as shown in FIG. 1, involves a moveable probe 12 and a set of sonic transducers 14. The probe 12 comprises a sonic sound transmitter 30 (as in FIG. 2), such as a piezoelectric crystal, which generates an intensity waveform of sound, such as an impulse or several cycles of high frequency sound, at regular intervals. In FIG. 1, the transmitted waveform follows direct paths 28 from the sound transmitter 30 to each of the sonic transducers 14. Each sonic transducer, functioning as a microphone, converts the received sonic waveform into an electrical waveform.

The sonic waveform transmitted by sonic transmitter 30 (shown in FIG. 2) is initiated by an electronic timing and control circuit 10, which concurrently resets one or more timers (such as a digital counter incrementing every microsecond or faster). The circuit 10 then registers the elapsed time when the sound waveform is received at each of the transducers 14 and is thereby converted into an electrical waveform. Because the waveform has a finite duration, the timing might measure from the completion of transmission of the waveform from the transmitter 30 until the completion of reception of the complete waveform at a given transducer 14. A more accurate and sophisticated method would be to perform mathematical correlation between the transmitted waveform with the full received waveform by varying the estimated delay time until a maximum value is produced by the correlation.

The control circuit 10 would preferably filter out superfluous noise using well-known techniques (such as a band-pass filter) and reject any waveforms which may have taken an indirect path. Such an indirect path 29 might be one in which the waveform internally reflects off the inside surface or surfaces of the portion of the object, rather than taking the direct path 29 from transmitter 30 to a transducer 14. One way to do this for each transducer 14 is to ignore reception of any waveforms after receiving the first one. The control circuit 10 does not initiate another sonic transmission from sonic transmitter 30 until no further sound from indirect paths is likely. For example, no further waveforms would be expected after waiting several milliseconds in an application involving human anatomy. So control circuit 10 could safely initiate a new waveform as frequently as every 1/100 of a second.

The computation unit 16 obtains from the timing and control circuit 10 the “time-of-flight” of the waveform from the transmitter 12 to each transducer 14. Given the speed of sound through the material of the object or anatomy, the distance between the transmitter 12 and each transducer 14 is easily computed by multiplying the speed times the time. The nominal speed of sound through human tissue is approximately the same speed as in water, which is 1540 meters per second. Then given the known 3-d location of each of at least three non-collinear transducers 14 (the XYZ coordinates in some coordinate system 26), the location of the probe (in the coordinate system 26) may be computed by a well-known triangulation computation (essentially the intersection point of three spheres centered on the three transducers 14 respectively, with radii equal to the three “time-of-flight” distances. (With only three transducers, there actually are two possible solutions, one if which sometimes can be obviously eliminated. For unambiguous results, at least four transducers 14, not all in the same plane, should be used.) If more then three transducer distances and locations are known, some suitable weighted best-fit computation should be used. If the peak intensity of the received waveform is available in addition to the time-of-flight, the relative peak intensity corresponding to each distance could be used to weight the best-fit computation. Alternatively, the computation could simply discard all but the three most intense waveforms for the computation. (Although the discarded waveforms would nevertheless be used to remove the two-point ambiguity present with only three distances.)

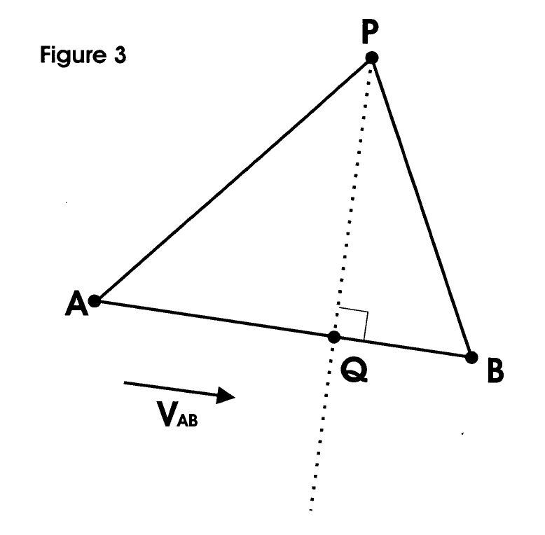

There is a more direct computation of the location of the sonic transmitter which does not involve dealing directly with spheres. Assume that point P is the location of the probe transmitter, that A and B are two transducers, and that Q is the point on line AB such that line PQ is perpendicular to AB. See FIG. 3. The using a simple analytic geometry derivation, we have that
(|AB|²+|AP|²−|BP|²)/(2*|AB|)=|AQ|
where |AB| is the calibrated distance between the transducers and |AP| and |BP| respectively are the sonically measured distances between the transmitter and the two transducers. (Assume that the location of each transducer or transmitter is the center of the area of contact with the object.) Therefore, point QAB is computed as
Q_{AB}=(|AQ_{AB}|*B+|BQ_{AB}|*A)/|AB|
where points Q_{AB}, A, and B in three dimensions are each represented as a coordinate triple. Furthermore, let V be the unit vector parallel to line AB. In vector notation,
V_{AB}=(B−A)/|AB|

The equation for the plane containing P and perpendicular to AB is
V_{ABx}*X+V_{ABy}*Y+V_{ABz}Z=V_{AB}*Q_{AB}
where V_{AB}*Q_{AB} is the scalar product of two coordinate triples. Then given the coordinates of a third transducer at location C, similarly find the equations of the two planes through P which are respectively perpendicular to lines AC and BC. This involves computing the unit vectors parallel to those lines. Then the location coordinates of point P are the solutions for X, Y, and Z in the set of three equations representing the three planes. X, Y, and Z may be computed using the well-known Kramer's rule.

If there are more than three transducers, there would be more than three of the above equations with the three variables X, Y, and Z. Then one could compute a least-squares, best-fit solution using well-known techniques. Alternatively, one could find the solutions for all combinations of three transducers at a time, and then compute the weighted average of all the solutions, where the weights are proportional to the “merit” of each three-transducer combination. The merit might be chosen to be the area of the three-transducer triangle times the product of the peak amplitude of the waveform for each transducer.

Besides the sonic transmitter 30, the probe 12 may house a sensor 32. Sensor 32 may measure some physical attribute of the object or anatomy such as the temperature at the point of contact, the color, the elasticity of the surface under the probe, the electrical conductance, or the ultrasonically measured internal geometry. Such data in conjunction with the probe's 3-d coordinates at the point of measurement would permit the accumulation of a geometrically-related mapping of the acquired attribute data.

Alternatively, the sensor 32 may be a set of three orthogonal accelerometers which detect the orientation of the probe with respect to gravity. Assuming that the contact surface of the probe is flat and that the probe surface must contact the object's surface more or less tangentially in order to operate, then the accelerometers can detect partial information about the vector normal to the physical surface of the object 99 at the point of contact. However, there would be ambiguity regarding the probe orientation about the vertical axis. Adding a magnetic detector, also part of sensor 32, to detect the orientation of the probe with respect to the Earth's magnetic field could yield a complete estimate of the normal vector at the point of contact. This probe orientation information would be particularly helpful in splicing together 2-d ultrasound image slices, if the probe also included a conventional ultrasound imaging transducer.

Note that the sound paths are expected to follow straight lines from the transmitter 30 through the material 99 to each transducer 14. This suggests that the portion of anatomy (or other object) must be more or less convex and contain no significant cavity. This limitation can be relaxed by including a sufficient number of transducers 14 at well distributed locations, so that at least three transducers 14, not along a straight line, do receive the sound along direct paths from any point on the surface. However, transducers not receiving the sound directly will record an arrival time longer than expected (either being reflected off or refracting around an intervening interior surface). The computation unit 16 can estimate a best-fit location of the transmitter 30, then eliminate inconsistent paths (for example, any longer than expected from the best-fit location), and repeat the estimation until all remaining paths entail a single consistent location for the probe.

Furthermore, note that the sound paths are expected to traverse the object through homogeneous material or at least through materials which transmit sound at approximately the same speed. This may not be true for many objects of interest—in particular human limbs. The speed of sound through fat is 1450 m/s (meters per second), while through muscle it is 1585 m/s (from Beverly Stern, The Basic Concepts of Diagnostic Ultrasound, Yale-New Haven Teachers Institute). However, the nominal speed through a mix of soft tissue is often taken to be 1540 m/s. However, bone transmits sound much faster: 4080 m/s. This speed differential at the boundary of bone and soft tissue means most of the sound is reflected back off bone rather than being transmitted into and through it. So a sound along a path traversing a long bone will tend to refract around the bone—following a path slightly longer than the direct path—rather than traverse through it. Such longer-than-expected paths can be eliminated if enough other transducers exist with direct paths from the probe.

For objects with soft surfaces, or with surfaces of varying softness (elasticity), the contact pressure of the probe may locally distort the surface inward by an unknown amount and therefore provide incorrect computed coordinates for the surface point when it is undistorted. This can be mitigated either actively or passively or both. Passive mitigation might simply mean providing a contact base for the probe with enough area to diminish the inward displacement by spreading forces over a broader area. Active mitigation might measure the contact force of the probe, estimate the elasticity (the spring constant in meters per newton) at the contact point, and compute a correction distance to be applied to the model being constructed.

One way to estimate the elasticity is to compute the change in probe location divided by the change in applied force (using a pressure gauge built into the probe, such as sensor 32) as the applied force changes from zero to some maximum and back to zero at a given sample point. Relating the change in distance relative to distortion force would require calibration, because the area of the probe contact area is also a factor. This approach would require the user to use a “hopping” measurement technique in which the probe is placed into contact with the object surface (non-zero force), then removed from contact with the surface (zero force), and then moved to the next contact sample point on the surface in the same manner. That is, a sequence of measurements would be taken at each sample point which characterizes the dynamics of the contacting, distorting action, thereby providing an estimate of the elasticity (force/displacement ratio). A simpler method would merely reject all measurements with more than a light contact pressure. That is, the invention would use only the surface geometry measurements taken when the probe just touches the surface hard enough to allow the sound waveform from the transmitter 30 to enter the object. The system would simply assume that with the light contact pressure little or no distortion has occurred.

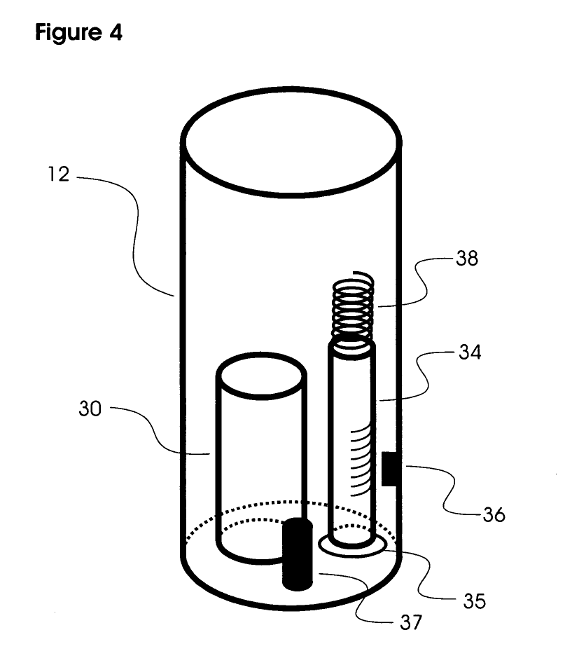

There is a more complex embodiment for estimating the elasticity—for the purpose of computing the surface distortion from the contact pressure—an embodiment which does not require the “hopping” technique. That is, this embodiment would allow the probe 12 to be smoothly slid along the surface of the object 99 while maintaining sufficient contact pressure to insure that the sonic transmitter 30 can inject sound into the object 99. This embodiment adds at least one spring-loaded plunger 34 to the probe, where the contact face of the plunger is much smaller than the contact face of the whole probe. In simplified form, this is shown in FIG. 4, where the sound transmitter 30 is shown separately, although the transmitter would advantageously be integral plunger 34. The plunger can protrude through hole 35.

A linear displacement sensor 36 adjacent to the plunger would return the amount of linear plunger displacement as the plunger presses further into the soft surface than does the rest of the probe face. Spring 38 has a known spring constant (force/displacement ratio) and it tries to push plunger 34 into the surface of object 99 relative to the contact base of probe 12. The softer the material, the larger the local “dimple” and the larger the displacement of plunger 34. (The plunger 34 and displacement sensor 36 could simply be the sensor 32 of FIG. 2 or could be in addition to sensor 32.) The plunger would apply further pressure (force per area) to the object's surface over a small area—in addition to the pressure of the whole probe face itself. Knowing the plunger displacement and the given plunger spring constant, the computation unit 16 could compute the elasticity of the surface of the object at the point of contact. Then given the contact pressure of the whole probe (measured by a separate sensor 37) and the computed elasticity, the displacement distance of the surface from the force of the whole probe can be estimated. This whole calculation would be a straightforward application of elementary physical mechanics, in which force equals the spring constant times displacement. Note that the ratio of plunger and whole probe contact surface areas must also be factored in.

The method of this invention begins by affixing the transducers 14 in contact with the object of interest 99, establishing a coordinate system, and calibrating the coordinates of the locations of the transducers within that coordinate system. Thereafter, the probe 12 is placed on a first sample location of the object 99. The timing and control circuit 10 causes the sound transmitter 30 in probe 12 to generate a waveform of sound. Then the transducers 14 each report the arrival of the sound waveform and therefrom circuit 10 acquires the transit time of the sound waveform. From those times, computational unit 16 computes probe-to-transducer path distances 28 and from those computes the XYZ coordinates of the sound transmitter 30 and the probe 12 using 3-d triangulation. Essentially simultaneously, the sensor 32 measures a physical attribute at the first sample location. The value of that attribute is recorded and associated with that location. Then the probe 12 is moved to another location, its location coordinates and attribute value are similarly determined and recorded. The process is repeated until sufficient data is acquired from all over the surface of the object 99 in question. More than one measurement might be taken at each location, especially if elasticity and deformation are being measured.

Notice that the object of interest may be relocated or reoriented in space as long as it is maintained in a more or less fixed shape during the whole measurement acquisition. This is because the positions are relative to the attached transducers, not to some external frame of reference, as would be the case with a typical 3-d optical or mechanical measurement system.

Once all the data has been acquired, the computational device 16 constructs a 3-d geometrical and physical model from the recorded data. Procedures for doing this are well-known in computer graphics: such as using the measurement locations to construct a Delauney triangular mesh to represent the surface. To create a smoothly curved surface the planar triangular facets could optionally be converted to smooth curved patches (bi-cubic or NURBS). Once the model is constructed, the model is rendered on display unit 18—such as a Gouraud smoothly shaded perspective view. In a preferred embodiment, the user finally can interactively rotate, scale, and pan the rendered view of the model. The values of the physical attribute are also rendered, perhaps as numeric values distributed on the visible surface at the corresponding locations. A more appealing rendering of the attribute's values might be to display each attribute value as a corresponding hue from the color spectrum.

It is assumed that sufficient data is collected to build a representative model. One measure of sufficiency is to require that there is at least one sample point within some given distance of any point on the portion of the model. Until that is the case, the system could direct the user to sample more points in any portion of the model for which the sampling is insufficient.

Either during or after the acquisition and recording of the locations and attribute values of contact points, but only if necessary, the XYZ coordinates are corrected for the distortion due to the contract pressure of the probe. This mitigation may be either passive (preventative) or active or both. If active, the coordinates of each point are adjusted by the estimated displacement, which comprises a vector normal to the local surface and a magnitude computed from the locally measured probe force and elasticity. This corrective mitigation would be applied individually to each recorded sample point.

One way to calibrate the locations of the transducers 14 affixed to the object 99 is to place the contact probe at a number of locations and record the sonic transit times to each of the transducers. Given the an assumed speed of sound, the distances between probe locations and the transducers can be computed. This leads to a set of equations of the form
(P_{i,x}−T_{j,x})²+(P_{i,y}—T_{j,y})²+(P_{i,z}−T_{j,z})²=D_{i,j}²
where P_{i,x} is the X coordinate of the i^{th} calibration point, T_{j,x} is the X coordinate of the j^{th} transducer, D_{i,j} is the measured (constant) distance between them, and so forth. Given sufficient probe calibration points, an arbitrary coordinate system, and using an known iterative technique, a best-fit solution can be found for the P and T variables. Such methods can be found in the classic work Numerical Recipes in C, by William H. Press, et al (Cambridge University Press).

Furthermore, if the actual distance between two widely spaced probe contact points is known, it can be compared to the distance implied by the calibration to check the assumed value for the speed of sound. Then, if the two distances are unequal, all the coordinates should be scaled by their ratio.

Note that the probe points need not be separately acquired beforehand; the system could simply use some or all the data taken for building the eventual model. That is, rather than recording the calculated coordinates of all the sampled locations during the sampling process, simply record the raw sonic transit times; at the end of data collection, post-process them as above to compute the locations of the transducers and the sample points.

In one enhanced embodiment, the transducers can also be used, one at a time, as transmitters for the purposes of automatically calibrating their locations with respect to each other. That is, instead of requiring the probe to be placed at various locations for calibration, each transducer acting as a sonic transmitter fulfills the role played by the probe in the calibration method described in a preceding paragraph. That is, assuming a given speed of sound in the medium of object 99, the transit time of the sound from each transducer to each other transducer fixes their separation distances. Given an arbitrarily created coordinate system, 3-d coordinates can be assigned to each transducer by an automatic computation. For example some particular transducer would be defined as the origin (0,0,0); another transducer would be defined as (X1,0,0) where X1 is the distance from the first transducer; a third (non-collinear) transducer would be at (X2,Y2,0), which implicitly defines the Y axis, where X2 and Y2 are such that the distances to (0,0,0) and (X1,0,0) are match the measured distances to the previous two transducers; the Z axis is defined perpendicular to the X and Y axis; and the pair-wise distances to the remaining transducers, if any, determine their coordinate triples also.

The advantage of doing calibration with the latter, enhanced embodiment is that the 3-d coordinate triples of the probe locations can be computed on the fly. This would allow the computation unit 16 to immediately render the model on display 18 as it is being constructed and the construction can happen in parallel with the data acquisition. This would provide feedback to the user to show where points have been sampled or not and how dense they are.

While this invention is described above with reference to a preferred embodiment and some variations, anyone skilled in the art can readily visualize other embodiments of this invention. For example, the probe many contain a more than one sensor, so that the value of each of plurality of physical or physiological attributes at each contact point can be acquired, recorded, modeled, and displayed. Therefore, the scope and content of this invention are not limited by the foregoing description. Rather, the scope and content are delineated by the following claims.

1. A method for acquiring the surface shape of a portion of an object relative to a 3-dimensional coordinate system, for measuring the values of a physical attribute at points over that portion, for automatically modeling the shape and the distribution of the values of the attribute, and for displaying a representation of the shape of the portion of the object and the values of the attribute at corresponding points on the shape representation;
comprising steps of
affixing at least three sound transducers in contact with the portion at fixed locations, so that the fixed transducers receive sound waveforms from the portion and convert them into electronic signals, and so that not all the transducers are located along a straight line;
establishing the 3-dimensional coordinate system fixed relative to the transducers and therefore also fixed relative to the portion;
calibrating the coordinates of each of the transducers within the coordinate system;
generating sound waveforms from a probe and conveying them into the portion so that the fixed transducers receive the waveforms when the probe is placed in contact with the portion;
moving the probe to a plurality of points of contact on the surface of the portion, such that at least one contact point is within a prescribed minimum distance from each point of the portion of body;
acquiring the distance between each contact point of the probe and each of the transducers by measuring the time required for the sound waveform to travel from the contact point to each transducer and multiplying that time by the speed of sound in the portion;
measuring the value of a physical attribute at each point where the probe contacts the surface by means of a sensor collocated in the probe;
maintaining the anatomical portion substantially invariant in shape during the preceding steps, except near where the probe may locally deform the surface shape due to the force of contact;
computing the 3-dimensional coordinates of each point of contact of the probe with the surface of the portion, given the distances between each contact point and at least some of the transducers, and given the calibrated coordinates of the transducers and the speed of sound within the portion;
mitigating any local surface deformation due to the contact force of the probe at the point of contact;
recording the measured value of the attribute at each contact point along with the coordinates of the point of contact;
constructing from the recorded coordinates and corresponding measurements a 3-dimensional model of the surface shape and the distribution of the measured values of the attribute associated with the points on the surface shape; and
displaying a rendering of the model on a visual display device in a form for human visual interpretation.

2. The method of claim 1, wherein the affixing step places transducers so that every point on the surface of the portion connects to each of at least three transducers by a straight line sound path which passes entirely through the object.

3. The method of claim 1, wherein the calibrating step involves placing the probe at sufficiently many locations and using the sound transit times between the probe and the transducers and the known speed of sound in the portion to derive the spatial coordinates of each transducer in the coordinate system.

4. The method of claim 1, wherein the calibrating step involves placing the probe at sufficiently many locations, at least two of which are separated by a known distance, thereby deriving the spatial coordinates of each transducer in the coordinate system from the sound transit times between the probe locations and the transducers and determining the speed of sound in the portion.

5. The method of claim 1, such that in the calibrating step the fixed transducers are also capable of transmitting sound waveforms, and each transducer, one at a time and in turn, can transmit a waveform, the arrival of which is timed to each of the other transducers to establish their pair-wise distances to each other, thereby permitting automated derivation of the locations of the transducers.

6. The method of claim 1, wherein the probe is moved manually.

7. The method of claim 1, wherein the probe is moved using a robotic mechanism.

8. The method of claim 1, wherein the probe is moved by keeping the probe in contact with the portion while it is moved.

9. The method of claim 1, wherein the probe is moved by sequentially touching the probe to the portion at each contact point and removing it from contact with the portion between each contact point.

10. The method of claim 1, wherein the probe communicates with the generating and computing steps by means of a wireless link.

11. The method of claim 10, wherein the link utilizes infrared communication as the wireless link.

12. The method of claim 10, wherein the link utilizes radio communication as the wireless link.

13. The method of claim 1, wherein the probe communicates with the generating and computing steps by means of an electronic cable.

14. The method of claim 1, wherein the probe communicates with the generating and computing steps by means of an optical fiber cable.

15. The method of claim 1, wherein the attribute is temperature.

16. The method of claim 1, wherein the attribute is surface elasticity.

17. The method of claim 1, wherein the attribute is electrical conductivity.

18. The method of claim 1, wherein the object is an anatomical body and the attribute is the distance from the contact point to the nearest bone.

19. The method of claim 1, wherein the attribute is an ultrasound image of the interior of the object.

20. The method of claim 1, wherein the attribute is the angle between the surface normal at the point of contact and the direction of the gravitational acceleration.

21. The method of claim 1, wherein the attribute is the angle between the surface normal at the point of contact and the direction of the magnetic field of the Earth.

22. The method of claim 1, wherein the attribute is the surface normal direction at the point of contact.

23. The method of claim 1, wherein the mitigation step quantifies the deformation and compensates the computed coordinates for the deformation.

24. The method of claim 23, wherein the quantification and compensation is performed by measuring the force at the contact point, measuring the elasticity of the underlying portion at the point, and estimating the deformation at the point from the force and elasticity at the point.

25. The method of claim 1, wherein the mitigation step provides a sufficiently large contact surface on the probe to minimize the amount of deformation of the surface when no more than a minimal amount of contact force is applied by the probe on the portion.

26. The method of claim 1, wherein the mitigation step provides a means to set aside measurements taken when the force of the probe against the portion exceeds a force which only minimally deforms the surface at the contact point but still allows operation of the acquiring and measuring steps.

27. The method of claim 1, wherein the rendering step displays a shaded, opaque, perspective view of the surface shape.

28. The method of claim 1, wherein the rendering step displays the surface shape as a planar cross-section through the model.

29. The method of claim 1, wherein the rendering step displays the measurement values of the attribute as series of color hues, each hue associated with a sub-range of all the attribute's values in the model.

30. The method of claim 1, wherein the rendering step displays the measurement values of the attribute as numbers, each shown at the location corresponding to the value on the display of the surface shape of the model.

31. The method of claim 1, wherein the object is the anatomy of a living organism.

32. The method of claim 31, wherein the organism is an animal.

33. The method of claim 31, wherein the organism is a human being.

34. The method of claim 33, wherein the portion of the object is a portion of a human limb.

35. A system for acquiring the surface shape of a portion of an object relative to a 3-dimensional coordinate system, for measuring the values of a physical attribute at points over that portion, for automatically modeling the shape and the distribution of the values of the attribute, and for displaying a visual representation of the shape of the portion and the values of the attribute at corresponding points on the shape representation;
comprising
a 3-dimensional coordinate system;
a plurality of sound transducers, each fixed at a location and in contact with the portion, not all located along a straight line, each located at a determinable location in the coordinate system, and each configured to receive a waveform of sound from the portion of the object and convert the sound into an electronic waveform;
a probe configured for contact with the portion and comprising a sound transmitter to convert an electronic waveform into a waveform of sound and to convey the sound into the portion, and also comprising a sensor capable of measuring the physical attribute at each point where the probe contacts the portion;
a timing circuit, which controls the formation, transmission, reception, and detection of sound waveforms and of timing their transmission and reception, where the waveform is transmitted from the sonic transmitter of the probe and received by at least some of the transducers, and where the circuit measures the transit time of the sound between the probe transmitter and each transducer along an essentially straight line path;
a digital computer, which communicates with the timing circuit,
converts the sound transit times between the probe and at least three transducers into distances,
computes the spatial coordinates of the location of each contact point from the distances between the probe at that contact point and the at least three transducers,
records the spatial coordinates of the contact point of the probe as it is moved to various locations on the portion,
adjusts the spatial coordinates to compensate for the force of the probe at the contact point if the force and the elasticity are known at the point of contact,
records the value of the attribute measured by the sensor at each contact point, and constructs from the recorded coordinates and measurement values a 3-dimensional geometric model of the shape of the portion of object over which the probe has taken the location and attribute measurements;
a graphical display, which renders a representation of the 3-dimensional geometrical shape of the portion and which renders a representation of the physical measurement values, where each measurement value displayed on the graphical display is at display locations corresponding to the display location of the representation for that location on the geometrical shape.

36. The system of claim 35, wherein the shape is shown as a shaded image.

37. The system of claim 35, wherein the rendered representation may be interactively rotated and magnified by an operator of the system.

38. The system of claim 35, wherein the various values of the physical measurements are show as different colors on the representation of the shape.

39. The system of claim 35, wherein the transducers are adhesively attached to the portion.

40. The system of claim 35, wherein the transducers are attached to one or more bands which may be fixedly attached to the portion.

41. The system of claim 35, wherein the transducers are attached to an elastic covering which may be fitted around the portion.

42. The system of claim 35, wherein the transducers are piezoelectric transducers.

43. The system of claim 35, wherein the transducers are located such that every point on the surface of the portion is related to each of at least three transducers by a straight line sonic path that passes entirely through the portion.

44. The system of claim 35, wherein the sound transmitter is a piezoelectric transducer.

45. The system of claim 35, wherein the sensor measures the temperature at the point of contact.

46. The system of claim 35, wherein the sensor measures the surface elasticity at the point of contact.

47. The system of claim 35, wherein the sensor measures the electrical conductivity at the point of contact.

48. The system of claim 35, wherein the sensor measures the distance from the point of contact to the nearest bone, where the portion is a portion of an anatomical body.

49. The system of claim 35, wherein the sensor returns an ultrasound image of the interior of the portion acquired at the point of contact.

50. The system of claim 35, wherein the probe is manually moved.

51. The system of claim 35, wherein the probe is robotically moved.

52. The system of claim 35, wherein the probe is moved by keeping the probe in contact with the portion while it is moved.

53. The system of claim 35, wherein the probe is moved by sequentially touching the probe to the portion at each contact point and removing it from contact with the portion between each contact point.

54. The system of claim 35, wherein the probe can measure the force of contact and the elasticity of the portion at the point of contact.

55. The system of claim 35, wherein the timing circuit also measures the transit time of the sound between each transducer acting as a transmitter and each other fixed transducer acting as a receiver so as to determine the locations of each transducer in the coordinate system.

56. The system of claim 35, wherein timing circuit comprises a high speed counter, which operates at a frequency of at least 1 million counts per second, records a start time when a sound waveform is transmitted by the probe, and records the time when that waveform is first received by each transducer.

57. The system of claim 35, wherein timing circuit generates an electronic waveform for the probe, which in turn generates an impulse of sound.

58. The system of claim 35, wherein timing circuit generates an electronic waveform for the probe, which in turn generates a sequence of a prescribed number of cycles of a prescribed shape and prescribed frequency.

59. The system of claim 35, wherein the timing circuit communicates with the probe over a digital electronic cable.

60. The system of claim 35, wherein the timing circuit communicates with the probe over a wireless link.

61. The system of claim 60, wherein the wireless link uses infrared light.

62. The system of claim 60, wherein the wireless link uses radio waves.

63. The system of claim 35, wherein timing circuit communicates with each transducer over an electronic conductor.
